(19) United States
(12) Patent Application Publication
(10) Pub. No.: US 2016/0363156 A1
(43) Pub. Date: Dec. 15, 2016

(54) WEDGE-LOCK NUT ASSEMBLY

(71) Applicant: GM GLOBAL TECHNOLOGY OPERATIONS LLC, Detroit, MI (US)

(72) Inventors: Jamieson D. Yonker, Canton, MI (US); Michael J. Palecek, Grand Blanc, MI (US)

(21) Appl. No.: 14/737,751

(22) Filed: Jun. 12, 2015

(51) Int. Cl. F16B 39/282

(52) U.S. Cl. CPC F16B 39/282

(57) ABSTRACT

A lock nut assembly configured to couple to a threaded bolt includes a base nut having a bore with an angled inner wall defining and angled ramp portion, the base nut bore configured to receive the threaded bolt, and a lock nut having an angled outer wall defining a wedge portion. The lock nut is configured to threadably engage the threaded bolt such that the wedge portion is driven into the angled ramp portion, the angled inner wall is configured to force the wedge portion to exert a clamping force against the threaded bolt to lock the base nut in place.

### FIELD OF THE INVENTION

The subject invention relates to lock nuts and, more specifically, to a wedge-lock nut assembly to maintain preloads.

### BACKGROUND

Nuts are widely used in various industries to fasten components in various kinds of devices. However, nuts may gradually lose clamp load through vibration of the assembly. Lock nuts are utilized to prevent loss of clamp load due to nut back-off from a bolt. Traditional methods of preventing nut back-off and loss of clamp load include staked nuts, prevailing torque nuts, thread-locking compounds, and lock nuts.

### SUMMARY OF THE INVENTION

In one aspect, a lock nut assembly configured to couple to a threaded bolt is provided. The lock nut assembly includes a base nut having a bore with an angled inner wall defining an angled ramp portion, the base nut bore configured to receive the threaded bolt, and a lock nut having an angled outer wall defining a wedge portion. The lock nut is configured to threadably engage the threaded bolt such that the wedge portion is driven into the angled ramp portion, the angled inner wall is configured to force the wedge portion to exert a clamping force against the threaded bolt to lock the base nut in place.

In another aspect, a lock nut assembly configured to couple to a threaded bolt is provided. The lock nut assembly includes a base nut having a threaded first bore and a second bore with an angled inner wall defining an angled ramp portion, the base nut threaded bore configured to receive and threadably engage the threaded bolt. The assembly further includes a lock nut having an angled outer wall defining a wedge portion, and a plurality of slits formed in the wedge portion and extending from a first end of the lock nut. The plurality of slits define a plurality of tabs of the wedge portion. The lock nut includes a threaded third bore configured to threadably engage the threaded bolt such that the wedge portion is driven into the angled ramp portion, the angled inner wall configured to force the plurality of tabs to exert a clamping force against the threaded bolt to lock the base nut in place.

In yet another aspect, a method of fabricating a lock nut assembly configured to couple to a threaded bolt is provided. The method includes forming a base nut having a bore with an angled inner wall defining an angled ramp portion, the base nut bore configured to receive the threaded bolt, and forming a lock nut having an angled outer wall defining a wedge portion. The lock nut is configured to threadably engage the threaded bolt such that the wedge portion is driven into the angled ramp portion, the angled inner wall configured to force the wedge portion to exert a clamping force against the threaded bolt to lock the base nut in place.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of an exemplary wedge-lock nut assembly before assembly;

FIG. 2 is a cross-sectional view of the nut assembly shown in FIG. 1 taken along line 2-2;

FIG. 3 is a perspective view of the nut assembly shown in FIG. 1 after assembly; and

FIG. 4 is a cross-sectional view of the nut assembly shown in FIG. 2 taken along line 4-4.

### DETAILED DESCRIPTION

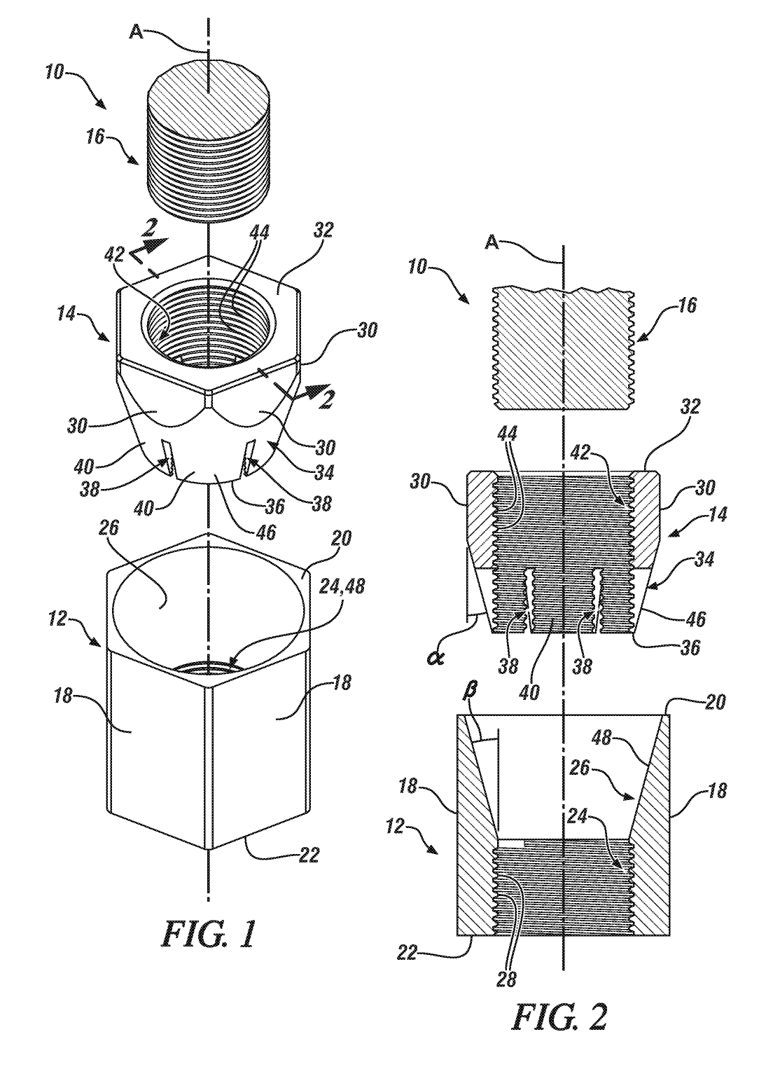

FIG. 1 illustrates an exemplary wedge-lock nut assembly 10 that generally includes a base nut 12, a wedge-lock nut 14, and a threaded bolt 16. Base nut 12 is threaded onto bolt 16 to a desired position, and wedge-lock nut 14 is subsequently threaded onto bolt 16 until it is positioned at least partially within base nut 12. As wedge-lock nut 14 is inserted into base nut 12, base nut 12 forces portions of wedge-lock nut 14 to apply a clamp load onto threaded bolt 16. As such, wedge-lock nut assembly 10 is a two-piece assembly that applies a radial clamp load on bolt 16 and creates a frictional contact between the two pieces to maintain a position of nut 12.

In the exemplary embodiment, base nut 12 is a hex nut having six flats 18 of uniform size and shape, an upper first seat surface 20, and a lower second seat surface 22. With additional reference to FIG. 2, base nut 12 includes a threaded inner bore portion 24 and an angled ramp portion 26. Threaded inner bore portion 24 includes a plurality of threads 28 configured to threadably engage threaded bolt 16.

In the exemplary embodiment, wedge-lock nut 14 is a hex nut having six flats 30 of uniform size and shape, an outer first surface 32, wedge portion 34, and an inner second surface 36. In the illustrated embodiment, wedge portion 34 is conical or substantially conical and includes one or more reliefs or slits 38 formed therein. As shown in FIGS. 1 and 2, adjacent slits 38 extend from surface 36 toward outer surface 32 to generally define a plurality of tabs 40. In the illustrated embodiment, wedge portion 34 is formed with six slits 38 defining six tabs 40. However, wedge-lock nut 14 may be formed with any suitable number of slits 38 that enables assembly 10 to function as described herein. With additional reference to FIG. 2, wedge-lock nut 14 includes a threaded inner bore portion 42 that includes a plurality of threads 44 configured to threadably engage threaded bolt 16.

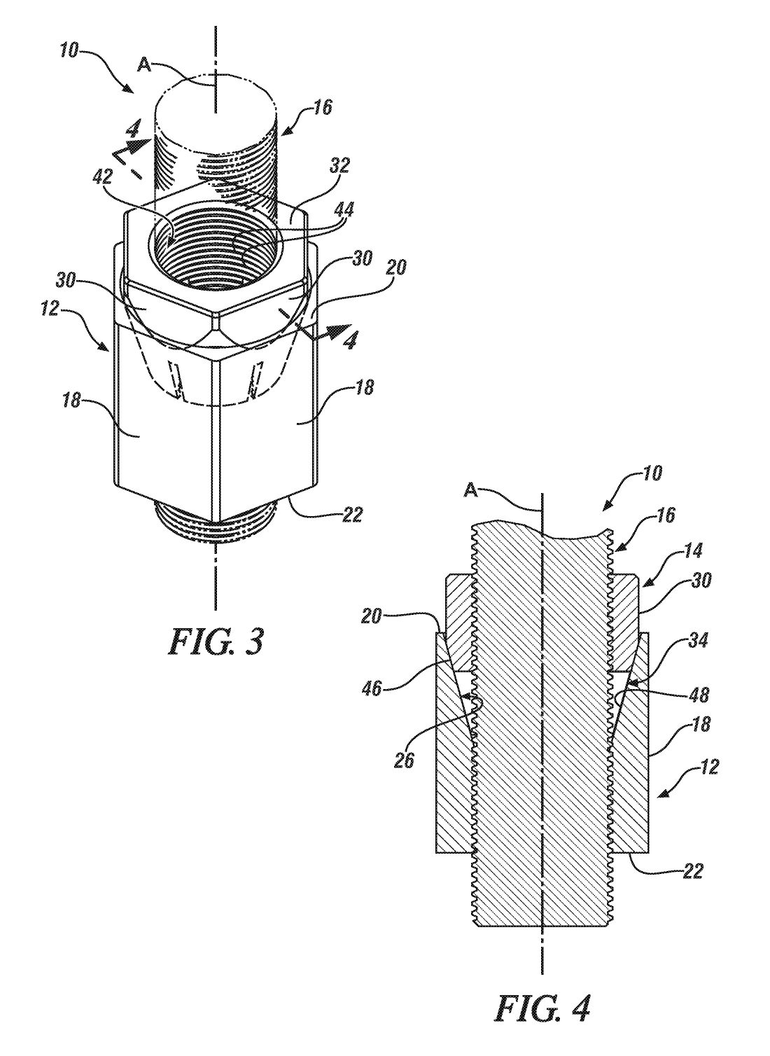

With additional reference to FIG. 3, assembling wedge-lock nut assembly 10 includes threading base nut 12 onto threaded bolt 16 such that lower seat surface 22 is seated against a component to be secured (not shown). For example, base nut 12 may be utilized to provide a desired pre-load for a bearing, a pinion, an axle shaft, or the like.

Once base nut 12 is in a desired position and/or provides a desired pre-loading against the component, wedge-lock nut 14 is threaded onto threaded bolt 16. As wedge-lock nut 14 is translated toward base nut 12, wedge portion 34 is inserted into or mates to angled ramp portion 26 until an outer wall 46 of wedge portion 34 contacts an inner wall 48 of angled ramp portion 26. At this point, as wedge-lock nut 14 is translated further toward base nut lower seat surface 22, inner wall 48 forces tabs 40 toward threaded bolt 16, the movement of which is facilitated by slits 38 and outer wall 46 being oriented at an angle ‘α’ (relative to a bolt axis ‘A’) that is less than inner wall 48 oriented at an angle ‘β’ (FIG. 2). As such, applying a small torque to wedge-lock nut 14 produces a large positive clamping force on bolt 16 as tabs 40 grip bolt 16 and lock in the component position and/or pre-load.

A method of fabricating wedge-lock nut assembly 10 includes forming base nut 12 and wedge-lock nut 14. Base nut 12 is formed with seat surface 20, seat surface 22, threaded inner bore 24, and angled ramp portion 26. Wedge-lock nut 14 is formed with outer surface 32, wedge portion 34, and inner surface 36. Wedge portion outer wall 46 is oriented at angle ‘α’, and angled ramp portion inner wall 48 is oriented at angle ‘β’ relative to bolt axis ‘A’. Angle ‘α’ is less than angle ‘β’ such that outer wall 46 contacts inner wall 48 as wedge-lock nut 14 is inserted into the base nut 12. Slits 38 are formed in edge portion 34 to define one or more tabs 40.

Described herein are systems and methods for a wedge-lock nut assembly. The lock nut assembly includes a base nut and a wedge-shaped lock nut. The base nut includes an angled ramp surface that facilitates movement of the tabs of the lock nut radially into a bolt as the wedge-lock nut is threaded onto the bolt. As such, the base nut may be used to set a pre-load on a component (e.g., a bearing), and the wedge-shaped lock nut may be threaded on the bolt into frictional engagement with the base nut to apply a clamp load on the bolt and to maintain the base nut position and pre-load. Accordingly, the system prevents or reduces loss of bearing pre-load, provides positive clamp load onto the threaded bolt, simplifies confirmation of correct installation through torque and angle monitoring, and replaces unreliable staking tools with simple torque tools.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A lock nut assembly configured to couple to a threaded bolt, the lock nut assembly comprising:
a base nut having a bore with an angled inner wall defining an angled ramp portion, the base nut bore configured to receive the threaded bolt; and
a lock nut having an angled outer wall defining a wedge portion, the lock nut configured to threadably engage the threaded bolt such that the wedge portion is driven into the angled ramp portion, the angled inner wall configured to force the wedge portion to exert a clamping force against the threaded bolt to lock the base nut in place.

2. The assembly of claim 1, wherein the base nut further includes a threaded inner bore configured to threadably engage the threaded bolt.

3. The assembly of claim 1, wherein a plurality of slits is formed in the lock nut wedge portion to define at least one tab.

4. The assembly of claim 1, wherein six slits are formed in the lock nut wedge portion to define six tabs, wherein the angled inner wall is configured to facilitate movement of the tabs inwardly to exert the clamping force against the threaded bolt.

5. The assembly of claim 1, wherein the threaded bolt defines a bolt axis, the angled inner wall oriented at a first angle relative to the bolt axis, and the angled outer wall oriented at a second angle relative to the bolt axis, wherein the second angle is less than the first angle.

6. The assembly of claim 1, wherein the base nut is hexagonal.

7. The assembly of claim 1, wherein the lock nut is hexagonal.

8. The assembly of claim 1, wherein the lock nut includes a threaded inner bore configured to threadably engage the threaded bolt.

9. A lock nut assembly configured to couple to a threaded bolt, the lock nut assembly comprising:
a base nut having a threaded first bore and a second bore with an angled inner wall defining an angled ramp portion, the base nut threaded bore configured to receive and threadably engage the threaded bolt; and
a lock nut having an angled outer wall defining a wedge portion, a plurality of slits formed in the wedge portion and extending from a first end of the lock nut, the plurality of slits defining a plurality of tabs of the wedge portion,
wherein the lock nut includes a threaded third bore configured to threadably engage the threaded bolt such that the wedge portion is driven into the angled ramp portion, the angled inner wall configured to force the plurality of tabs to exert a clamping force against the threaded bolt to lock the base nut in place.

10. The assembly of claim 9, wherein the base nut and the lock nut are hexagonal.

11. The assembly of claim 10, wherein the threaded bolt defines a bolt axis, the angled inner wall oriented at a first angle relative to the bolt axis, and the angled outer wall oriented at a second angle relative to the bolt axis, wherein the second angle is less than the first angle.

12. A method of fabricating a lock nut assembly configured to couple to a threaded bolt, the method comprising:
forming a base nut having a bore with an angled inner wall defining an angled ramp portion, the base nut bore configured to receive the threaded bolt; and
forming a lock nut having an angled outer wall defining a wedge portion, the lock nut configured to threadably engage the threaded bolt such that the wedge portion is driven into the angled ramp portion, the angled inner wall configured to force the wedge portion to exert a clamping force against the threaded bolt to lock the base nut in place.
